(19) United States
(12) Patent Application Publication
(10) Pub. No.: US 2010/0057614 A1
(43) Pub. Date: Mar. 4, 2010

(54) SYSTEM AND METHOD FOR EFFECTING REAL-TIME FINANCIAL TRANSACTIONS BETWEEN DELAYED-SETTLEMENT FINANCIAL ACCOUNTS

(75) Inventors: Nanci Rainey, Atlanta, GA (US); Steven M. Smith, Atlanta, GA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/437,475

(22) Filed: May 7, 2009

Related U.S. Application Data
(60) Provisional application No. 61/091,770, filed on Aug. 26, 2008.

(51) Int. Cl. G06Q 40/00

(52) U.S. Cl. 705/42; 705/39; 705/44

(57) ABSTRACT

A system and method for effecting a substantially real-time financial transaction between at least one secure account linked to a computer device, such as a checking account that ultimately has a delayed-settlement of financial transactions, and one other financial account, such as another secure account linked to another computer device. A financial services system allows remote computer devices, such as mobile computer devices, to store access codes, such as debit card numbers, for secure accounts and the financial services system can then effect a desired transaction over an existing electronic transaction network, such as an ATM/Debit network, thereby causing the financial transaction to occur substantially in real-time between secure accounts.

The present non-provisional application for patent claims priority to provisional application No. 61/091,770 entitled “SYSTEM AND METHOD FOR EFFECTING REAL-TIME FINANCIAL TRANSACTIONS BETWEEN DELAYED-SETTLEMENT FINANCIAL ACCOUNTS,” filed on Aug. 26, 2008, which is assigned to the assignee hereof and hereby expressly incorporated by reference herein.

### BACKGROUND OF THE INVENTION

1. Field of the Invention

The present invention relates to systems that effect financial transactions between financial accounts. More specifically, the present invention relates to a system and method that effect a substantially real-time financial transaction between checking accounts that otherwise have delayed financial transaction settlements, where the checking accounts are linked to computer devices, such as mobile computer devices.

2. Description of the Related Art

There exist systems that allow a real-time (or substantially real-time) financial transactions between financial accounts. In a standard transaction, a monetary amount is deducted from one account and credited to the benefit of another account. However, the financial transaction is not actually completed in real-time. In the transaction, an entity that effects the transaction will bear the financial risk of the transaction and take a charge against the account from which money is being deducted and then deposit money into the account to which the money is to be credited. If an error occurs in the transaction such that funds are ultimately insufficient or unavailable from the deducting account for the transaction, then that entity bears the financial risk for the transaction.

In regard to checking account transactions, the “Automated Clearing House” (ACH) is the name of an electronic network for financial transactions in the United States involving financial transactions for checking accounts. The ACH processes large volumes of both credit and debit transactions that are typically originated in batches. Both the US government and the commercial sectors use ACH payments which essentially function like traditional commercial paper (check) transactions.

The Federal Reserve Banks are collectively the largest automated clearinghouse operator and process the majority of commercial interbank ACH transactions. There also is an electronic payment network (EPN) that processes the remaining transactions, and the Reserve Banks rely on each other for the processing of some transactions in which either the originating depository financial institution (ODFI) or receiving depository financial institution (RDFI) is not their specific customer. In accordance with the rules and regulations of the ACH network, no financial institution may simply issue an ACH transaction (whether debit or credit) towards an account without prior authorization from the account holder (known as the “Receiver” in ACH terminology).

An ACH entry starts with a Receiver authorizing an Originator to issue ACH debit or credit to a checking account. An Originator can be a person or a company (such as the gas company, a local cable company, or an employer). Depending on the ACH transaction, the Originator must receive some written, verbal, or electronic authorization from the Receiver. Written authorization constitutes a signed form giving consent on the amount, date, or even frequency of the transaction. Verbal authorization needs to be either recorded audio or the Originator must send a receipt of the transaction details before or on the date of the transaction. An electronic authorization must include a customer reading the terms of the agreement and typing or selecting some form consent statement. Once authorization is acquired, the Originator then creates an ACH entry to be given to an ODFI, which can be any financial institution that does ACH origination. This ACH entry is then sent to an ACH Operator Network (usually the Federal Reserve) and is passed on to the RDFI, where the account of the Receiver is issued either a credit or debit, depending on the ACH transaction. The RDFI may, however, reject the ACH transaction and return it to the ODFI with the appropriate reason, such as that there were insufficient funds in the account or that the account holder indicated that the transaction was unauthorized.

There exists an electronic network that allows automated teller machines (ATMs) and debit cards to immediately withdraw and credit funds from and to checking accounts, outside the delay imposed by the ACH network, and the financial transactions are later settled up on the ACH network. There are also several “interbank” networks, enabling people to withdraw and deposit money from machines not belonging to the bank where they have their account or in the country where their accounts are held (enabling cash withdrawals in local currency). Some examples of interbank networks include PLUS, Cirrus, Interac and LINK. The ATMs point of access to an electronic transaction network is very secure, with a typical connection directly from an ATM controller via either a dial-up modem over a telephone line or directly via a leased line. In addition to methods employed for transaction security and secrecy, all communications traffic between the ATM and the ultimate transaction processor on the electronic network may also be encrypted via methods such as SSL.

Debit cards also provide a secure and virtually instantaneous transaction with a checking account using an electronic transaction network. There are currently two ways that debit card transactions are processed: online debit (also known as PIN debit) and offline debit (also known as signature debit). In the United States, these are often referred to at point of sale (POS) as “debit” and “credit” respectively, even though in either case the user's checking account is debited and no credit is involved.

Online debit cards require electronic authorization of every transaction and the debits are reflected in the user's checking account immediately. The transaction may be additionally secured with the personal identification number (PIN) authentication system and some online cards require this authentication for every transaction. One difficulty in using online debit cards is the necessity of an electronic authorization device at the POS and sometimes also a separate PIN input pad to enter the PIN. In the United States, most online debit transactions are handled by regional ATM networks, though VISA® and MasterCard® each own online debit networks. Online debit is usually provided as a secondary feature on an offline debit card (such as Visa® Check Card or Debit MasterCard®).

Offline debit cards typically have the logos of major credit cards (e.g. Visa® or MasterCard®) or major debit cards and are used at the point of sale like a credit card. Transactions conducted with offline debit cards require 2-3 days to be reflected on users' checking account balances. When a purchase is made using the “credit” (offline debit) option, the transaction merely places an authorization hold on the customer's checking account, and the funds are not actually withdrawn until the transaction is reconciled and hard-posted to the customer's account usually a few days later. There is accordingly a financial risk to the entity that credited the funds to the seller and must wait until the transaction is successfully completed from the account of the purchaser. In the US, offline debit transactions are typically processed through the Visa® or MasterCard® networks in the same manner as actual credit card transactions and, thus the risk of the transaction is born by those respective entities as they substantially “float” the money for the instantaneous financial transaction until the transaction can be completed in the normal course over the ACH network. Some merchants in the U.S. have recently been allowed to bypass the signature requirement for “credit” sales (including offline debit) if the total sale is under a certain dollar amount.

It is also known to credit funds to a debit card, such as a refund to a purchaser, and in such instances, the funds are almost instantaneously placed into the checking account linked to the debit card. In this scenario, the entity supporting the transaction basically conducts a purchase transaction in reverse, placing funds into the checking account of the purchaser and subtracting the funds from the account of the seller. Again, however, the transaction supporting entity bears the risk of insufficient funds or transaction failure in receiving the funds from the seller while having credited the account of the purchaser.

Accordingly, it would be advantageous to provide a system and method for allowing a financial transaction between checking accounts that occurs substantially in real-time, yet provides minimal risk to an entity in the event that the funds from the transaction are not recovered from the later account settlement. The system and method should be able to utilize existing systems to electronically effect financial transactions between checking accounts. It is thus to the provision of such a system and method that the present invention is primarily directed.

### SUMMARY OF THE INVENTION

Briefly described, the present invention includes a system and method for effecting a substantially real-time financial transaction between at least one secure account linked to a computer device, such as a checking account, and one other financial account, such as another checking account linked to another computer device. A financial services system allows remote computer devices, such as mobile computer devices, to store access codes for secure accounts, such as debit card numbers, and the financial services system can then effect a desired transaction over an existing electronic transaction network, such as an ATM/Debit network, thereby causing the financial transaction to occur substantially in real-time between secure accounts for computer devices where the financial services system preferably holds the access codes for the secure accounts of each device.

In one embodiment, the system for effecting a substantially real-time financial transaction between at least one secure account and one other financial account, that includes a secure account transaction network that manages financial transactions between a plurality of secure accounts, and at least one of the secure accounts having a first access code thereto. The system also includes an electronic transaction network that selectively communicates with the secure account network, and effects a substantially real-time financial transaction in a secure account on the secure account transaction network utilizing a first access code for that secure account. The system also includes a financial services system that is in selective communication with at least the electronic transaction network, and the financial services system receives financial transaction data from at least a first computer device having a user thereof where the user desires to conduct a financial transaction from at least a first secure account linked with the first computer device to a second secure account, and the financial services system stores first access codes for secure accounts linked with computer devices. Upon receipt of a financial transaction data from the first computer device, the financial services system effects the financial transaction specified in the financial transaction data with the electronic transaction network to effect the financial transaction from the first secure account to the second secure account substantially in real-time. The financial service system can also store the access codes for the second secure account to fully conduct the transaction on the electronic transaction network.

In one embodiment, the method for effecting a substantially real-time financial transaction between at least one secure account and one other financial account includes the steps of storing access codes for secure accounts linked with computer devices at a financial services system, with the access codes for secure accounts accessible to a secure account transaction network that manages financial transactions between a plurality of secure accounts with at least one of the secure accounts having a first access code thereto, and then receiving financial transaction data from at least a first computer device having a user thereof where the user desires to conduct a financial transaction from at least a first secure account linked with the first computer device to a second secure account. The method then includes the steps of effecting the financial transaction specified in the financial transaction data from the first secure account to the second secure account substantially in real-time through the financial services system communicating with an electronic transaction network that selectively communicates with the secure account transaction network, and the electronic transaction network effecting substantially real-time financial transactions in secure accounts on the secure account transaction network through utilizing access codes, with the electronic transaction network further effecting the specified financial transaction for the secure account based upon one or more access codes provided from the financial services system.

The present system and method are therefore advantageous in that they give the user of a computer device, such as a mobile computer device, the ability to conduct a substantially real-time financial transaction between checking accounts, such as making a payment to the checking account of another, yet provide minimal risk to an entity implementing the financial transaction in the event that the funds from the transaction are not recovered in the later account settlement. The system and method accomplish this purpose by utilizing the existing systems to electronically effect financial transactions between checking accounts, such as the ATM/Debit network and ACH network, including authentication, authorization, posting and settlement. Because of the use of existing payment infrastructure, the system and method do not require a user to open a separate account on the system, but rather, simply register existing access codes, such as debit card numbers and personal identification numbers (PINs) with a financial services system.

The present system and method are further advantageous to a financial service provider in that it enables the provider to capture incremental payment activity for the real-time transfers between checking accounts and the associated revenue for the service.

Other objects, features, and advantages of the present invention will become apparent after review of the Brief Description of the Drawings, Detailed Description of the Invention, and the Claims.

### BRIEF DESCRIPTION OF THE DRAWINGS

FIG. 1 is a representative diagram of a system embodied to conduct a substantially real-time financial transaction between two checking accounts linked with two mobile computer devices.

FIG. 2 is a block diagram illustrating the computer platform of the mobile computer device supporting a mobile financial transaction.

FIG. 3A is a representative diagram of the graphic user interface (GUI) on a first mobile computer device attempting a financial transaction from a checking account linked with that first mobile computer device and a checking account linked to the second mobile computer device.

FIG. 3B is a representative diagram of the GUI on the first mobile computer device and second mobile computer device in FIG. 3A, reflecting that the desired financial transaction has been completed.

FIG. 4 is a process flow diagram of one embodiment of a financial transaction completed between two mobile computer devices.

FIG. 5 is a flowchart of one embodiment of process of the financial services system receiving and completing a desired financial transaction between mobile computer devices.

### DETAILED DESCRIPTION OF THE INVENTION

In this description, the terms “computer device” means any device that has a computer platform and corresponding data processing, communication, and/or storage capability. A “mobile computer device” means a computer device that has a wireless communication capability, such as mobile phone, smartphone, personal digital assistant, laptop or other wireless computer platform. The terms “real-time” or “substantially in real-time” transaction means a transaction that is either completely instantaneously, or rapidly. The term “application” as used herein is intended to encompass executable and non-executable software files, raw data, aggregated data, patches, and other code segments. The term “exemplary” means that the disclosed element or embodiment is only an example, and does not indicate any preference of user. Further, like numerals refer to like elements throughout the several views, and the articles “a” and “the” includes plural references, unless otherwise specified in the description.

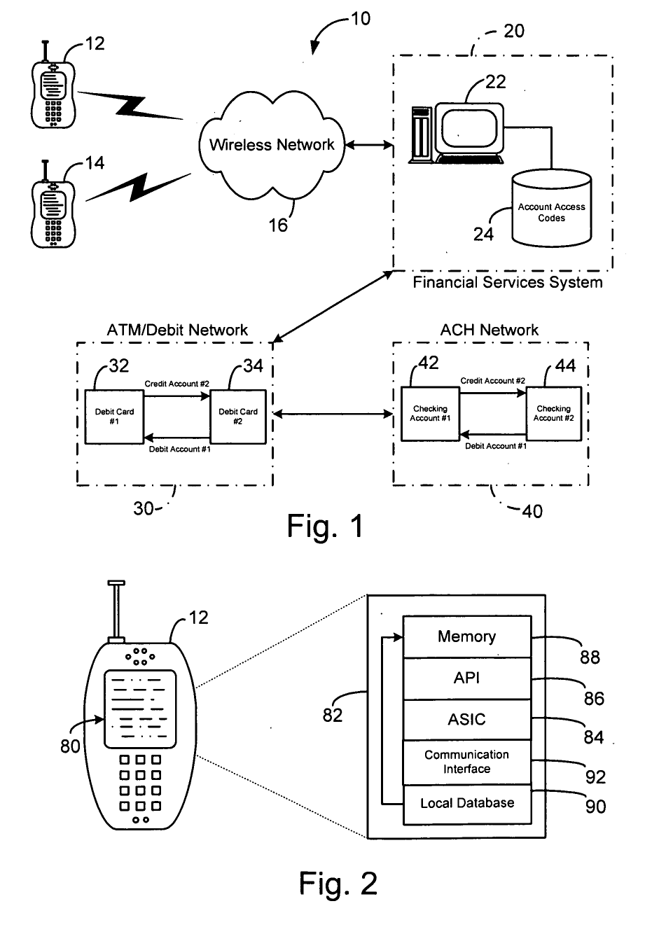

With reference to the figures in which like numerals represent like elements throughout, FIG. 1 illustrates one embodiment of a system 10 for effecting a substantially real-time financial transaction between at least one secure account, such as checking account #1 (42) and one other financial account, such as checking account #2 (44). The transaction can be effected between two computer devices, such as two mobile computer devices 12 and 14 in communication through a wireless network 16 to a financial services system 20. A secure account transaction network, such as the ACH network 40, manages financial transactions between a plurality of secure accounts, such as checking accounts #1 (42) and #2 (44) and reconciles funds transfer does so at a predetermined intervals such as at the close every business day, every three days, etc. At least one of the secure accounts has a first access code thereto, such as a debit card number or other electronic transaction number, such as debit card #1 (32) for checking account #1 (42).

An electronic transaction network, such as the ATM/Debit network 30 (e.g. PLUS, Cirrus, Interac and LINK, etc.) is configured to selectively communicate with the ACH Network 40 and effect a substantially real-time financial transaction in a secure account, such as checking account #1 (42) on the secure account transaction network utilizing a first access code, such as debit card #1 (32) for that secure account. Thus, the ATM/Debit network 30 will cause a substantially “real-time” transaction in a checking account by either placing a hold on an account when debited, or crediting funds to the checking account by basically an electronic funds transfer (e.g. a verified electronic deposit, wire transfer, etc.) into the checking account and bear the risk if the held funds are ultimately unavailable for withdrawal from the debited account.

A financial services system 20 is in selective communication with at least the electronic transaction network 30, and the financial services system 20 includes at least one transaction server 22 and a database 24 of stored access codes, such as debit card information liked to computer devices. The financial services system 20 is configured to receive financial transaction data, such as a payment transaction, from at least a first computer device, such as mobile computer device 12, having a user thereof where the user desires to conduct a financial transaction from at least a first secure account (such as checking account #1 (42)) linked with the to a second secure account, such as checking account #2 (44). The financial services system 20 is further configured to store the access codes (such as debit card #1 (32) and #2 (34)) for secure accounts (such as checking account #1 (42) and #2 (44)) linked with computer devices, such as mobile computer devices 12 and 14. It should be noted that other monetary and transactions for value can be performed in the present system and methodology, such as electronic coupons, reward points, gift-card balances, etc.

As shown in FIG. 2, the mobile computer device 12 includes several components: a computer platform 82 that controls the device functionality, to include communication capability from a communication interface 92, which can be voice and/or data, and one or more applications are resident upon the computer platform 82. In a common configuration, the ASIC chip layer 84 includes one or more application programming interfaces 86, such as a device-resident operating system or programming environment, such as BREW® which is a mobile programming environment supplied by QUALCOMM®.

As shown here, the wireless device can be a mobile telephone 14, with a graphics display 80, but can also be any wireless device with a computer platform 82 as known in the art, such as a personal digital assistant (PDA), a pager, handheld email device, smartphone, or even a separate computer platform that has a wireless communication portal, and may otherwise have a wired connection to a network or the Internet. Further, the memory 88 can be comprised of read-only or random-access memory (RAM and ROM), EPROM, EEPROM, flash cards, or any memory common to computer platforms. The computer platform 82 can also include a local database 90 for storage of software applications not actively used in memory 88. The local database 90 is typically comprised of one or more flash memory cells, but can be any secondary or tertiary storage device as known in the art, such as magnetic media, EPROM, EEPROM, optical media, tape, or soft or hard disk.

Thus, an application can be resident in the local storage 90 that allows the user of the mobile computer device 12 to access a financial transaction application resident therein. For example, Firethorn® provides a “mobile consumer wallet” that allows a user of a mobile computer device to store financial information in the local database 90 and securely access and interact with financial systems across the wireless network 16. Other financial applications resident on computer devices (mobile or remote) can be modified to perform the functionality as taught herein. Thus, the computer device-resident application can to hold at least access codes, such as debit card numbers and PINs for secure accounts linked with the mobile computer device 12. Furthermore, the resident application can be further configured to obtain financial account data for secure accounts linked to the mobile computer device 12, such as obtaining checking account data from financial institutions, and storing the financial account data at the mobile computer device 12. The financial account data stored at the mobile computer device 12 can therefore be updated based upon financial transactions effected from the mobile computer device 12 using the financial services system 20, or can reflect the actual balance in the checking account until all transactions are posted via the ACH network.

In one embodiment, a user of the computer device can access data at the computer device itself, or can enter the data at a remote web interface or other access to the financial services system 20. The access code information can include items such as debit card numbers and card expiration dates, a mobile transaction PIN or an additional security code to access the financial transaction application, and a list of potential payee users or computer devices and the appropriate payee contact information such as phone numbers or other identification.

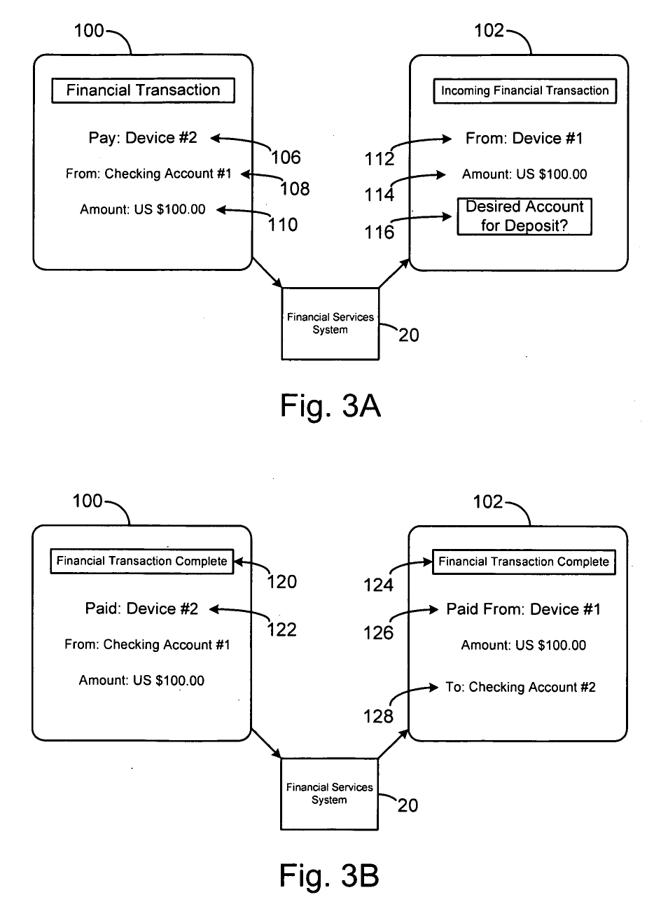

FIGS. 3A and 3B are a representative diagram of one embodiment of a graphic user interface (GUI) 100 on a first mobile computer device 12 attempting a financial transaction from a checking account #1 (108) linked with that first mobile computer device 12 and a checking account linked to the second mobile computer device 102. Thus, as an example, the user of the mobile computer device 112 desires to pay $100 (payment amount 110) to Device #2 (shown by payee 106) and pay that amount from Checking Account #1 (108). Upon receipt of the financial transaction data from the mobile computer device 12, the financial services system 20 is further configured to effect the financial transaction specified in the financial transaction data with the electronic transaction network 30 to effect the financial transaction from checking account #1 (108) to a checking account linked to the other mobile computer device 14, substantially in real-time.

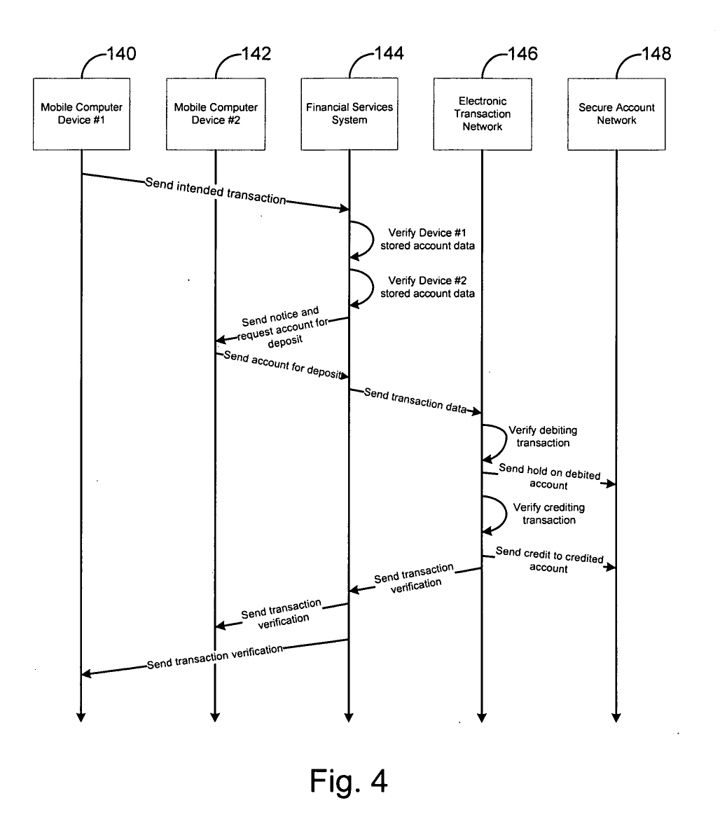

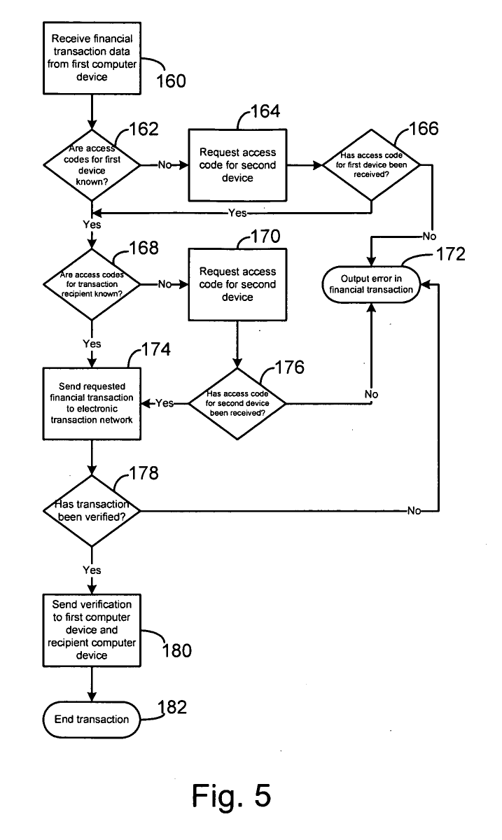

The financial services system 20 sends the desired financial transaction data to the second mobile computer device 14, and the GUI 102 of the second mobile device 14 then displays the paying device (payer 112), the amount being paid, here $100 (paying amount 114) and then asks the user of the second mobile device 14 to enter the desired checking account for the deposit to be made in, shown here as query 116. Once the checking account is specified, the financial services system 20 will complete the financial transaction utilizing the electronic transaction network 30, as is more fully described in FIGS. 4 and 5.

Once the financial transaction has been verified the financial services system 20 will notify the users of the first mobile computer device 12 and second mobile computer device 14, as shown in FIG. 3B. The GUI 100 on the first mobile computer device 12 shows that the financial transaction has been completed (confirmation 120) and shown that Device #2 was paid (paid device 122). The GUI 102 of second mobile computer device 14 likewise reflects that the desired financial transaction has been completed (confirmation 124) and indicates the payer (paid from icon 126) and the account in which the funds were credited (paid into account 126). Other financial information can also be displayed along with this information, such as current account balances (either actual current balance displaying in the secure account, or a reflecting the future balance once the ultimate transaction is completed).

Other methods can be used to begin the financial transaction, such as the first mobile computer device 12 sending an email, SMS, or other notice that the first mobile computer device 12 desires to pay the second mobile computer device 14. In such case, if the second mobile computer device 14 does not have any secure accounts registered with the financial services system 20, the user of the second mobile computer device 14 can do so in order to receive substantially real-time credit of the payment to a secure account. Such messaging can be done from the first mobile computer device 12 or from the financial services system 20. Also, the financial services system 20 can enforce the rules for financial transaction for the various financial institutions, such as a maximum money transfer limit per day, maximum transaction amount, etc.

FIG. 4 is a process flow diagram of one embodiment of a financial transaction completed between two mobile computer devices #1 (140) and #2 (142). The initial transaction request is sent from mobile computer device #1 (140) to the financial services system (144), which then first verifies whether or not it has the requisite data for mobile computer device #1 (140), e.g. that the debit card, PINs, and other information needed for that mobile computer device #1 (140) or the logged-in user to the financial services system 144 is accessible. Then the financial services system 144 verifies that it has the requisite information for mobile computer device #2 (142), e.g. it knows the requisite financial data for mobile computer device #2. If there is data lacking for mobile computer device #2 (142), e.g. the device has linked accounts, the user is known to the financial services system 144, etc., the financial services system 144 can generate a requisite message to mobile computer device #2 (142) to obtain the needed information, to include inviting the user of mobile computer device #2 (142) to join the financial service provided by the financial services system 144.

Here, there is more than one stored secure account for mobile computer device #2 (142) so the financial services system 144 sends a notice of the requested financial transaction to mobile computer device #2 (142) and requests the specific checking account that the user wishes the deposit to be made in, similar to the request displayed on the GUI 102 of the second mobile computer device 14 in FIG. 3A. Upon mobile computer device #2 (142) sending back the desired checking account for deposit, the financial services system 144 sends the financial transaction data to the electronic transaction network 146, e.g. the ATM/Debit network.

The electronic transaction network then verifies the debiting transaction for the checking account of mobile computer device #1 (140) and sends a hold to the requisite checking account which is effected on the secure account network (148), e.g. the ACH network, as is known in the art. Then the electronic transaction network 146 verifies the crediting transaction, e.g. the checking account for mobile computer device #2 (142) can be identified via the debit card number stored for mobile computer device #2 (142), and the electronic transaction network 146 then credits the appropriate checking account via the debit card on the secure account network 148. Once the crediting transaction is complete, the electronic transaction network 146 then sends a transaction verification to the financial services system 144, and the financial services system 144 will then send the verification of the financial transaction to mobile computer devices #1 (140) and #2 (142). Those devices can then display the verification in a manner similar to that shown in FIG. 3B.

FIG. 5 is a flowchart of one embodiment of process of the financial services system 20 receiving and completing a desired financial transaction between mobile computer devices 12 and 14. The financial services system 20 receives financial transaction data requested from a first computer device, such as mobile computer device 12, as shown at step 160, and then a determination is made as to whether the access codes are known for the first computer device, as shown at decision 162, e.g. are the debit card numbers and appropriate PINs known for the checking account from which money is to be debited. Alternately, the process can begin with an initial request for a payment from a mobile computer device 12 asking the financial services system 20 to request a payment from another computer device, such as mobile computer device 14.

If the access codes for the first computer device are not known at decision 162, e.g. a debit card number or PIN is needed to effect the transaction or checking account identified, then a request is made to the first computer device to send the requisite access codes to the financial services system 20, as shown at step 164, and then a determination is made as to whether the access codes for the first computer device have been received, as shown at decision 166. If the access codes for the first computer device have not been received at decision 166, then an error in the financial transaction is output and the specific financial transaction process terminated, as shown at termination 172. Otherwise, if the access codes for the first computer device have been received at decision 166, or if the access code were already known at decision 162, then a determination is made as to whether the access codes for the second computer device (the recipient of the funds here) is known, as shown at decision 168. For example, the financial services system 20 can determine if the second mobile computer device 14 is known, has one or more checking accounts linked, has the debit card numbers for the checking accounts, and/or needs to determine which account the user of the second mobile computer device 14 desires the funds to be deposited in.

If the access codes (or other information) are now known to the financial services system at decision 168, then a request is made to the second computer device (such as mobile computer device 14) for the access codes and/or other information, as shown at step 170, and then a determination is made as to whether the access code and/or other information has been received by the financial services system 20, as shown at decision 176. If the access codes have not been received from the second computer device at decision 176, then an error in the financial transaction is output and the specific financial transaction process terminates, as shown at termination 172. Otherwise, if the access codes for the second computer device have been received at decision 176, or if the access code were already known at decision 168, then the requested financial transaction is sent from the financial services system 20 to the electronic transaction network (such as ATM/Debit network 30) for completion.

A determination is then made as to whether the financial transaction has been verified from the electronic transaction network, as shown at decision 178. If the financial transaction has not been verified at decision 178, then an error in the financial transaction is output and the specific financial transaction process terminated, as shown at termination 172. Otherwise, if the financial transaction has been verified at decision 178, then a verification of the financial transaction is sent to the first computer device and second computer device, as shown at step 180, and then the financial transaction process ends as shown at termination 182.

It can thus be seen that system 10 provides a method for effecting a substantially real-time financial transaction between at least one secure account such as checking account #1 (42) in FIG. 1, and one other financial account, such as checking account #2 (44). The method includes the storing of access codes for secure accounts linked with computer devices at a financial services system 20, such as storing debit card numbers, PINs, etc., and the access codes for secure accounts accessible to a secure account transaction network, such as the ATM/Debit network 30, that manages financial transactions between a plurality of secure accounts with at least one of the secure accounts having a first access code thereto, such as a checking account having a debit card issued therefore. The method then includes receiving financial transaction data from at least a first computer device, such as mobile computer device 12, having a user thereof where the user desires to conduct a financial transaction from at least a first secure account linked with the first computer device to a second secure account, such as is illustrated in FIG. 3A. Then method then includes the step of effecting the financial transaction specified in the financial transaction data from the first secure account to the second secure account substantially in real-time through the financial services system 20 communicating with an electronic transaction network, such as the ATM/Debit network 30, that selectively communicates with the secure account transaction network, such as the ACH network 40, and the electronic transaction network (ATM/Debit network 30) effecting substantially real-time financial transactions in secure accounts (such as checking accounts) on the secure account transaction network (ACH network 40) through utilizing access codes (such as debit card numbers), with the electronic transaction network (ATM/Debit network 30) further effecting the specified financial transaction for the secure account based upon one or more access codes provided from the financial services system 20.

The step of storing access codes can be further storing an access code for the second secure account that is linked to a second computer device, such as mobile computer device 14. Such functionality would occur if the financial services system 20 needed the access codes from the second computer device prior to being able to complete the financial transaction.

When embodied with the secure account transaction network being the ACH network 40, effecting a financial transaction is effecting a financial transaction between checking accounts, such as between checking account #1 (42) and checking account #2 (44). In such embodiment, the electronic transaction network is an ATM/Debit network 30 and the access codes for the secure accounts are debit card numbers, the method further includes the user of the first computer device (mobile computer device 12) entering a personal identification number to effect the financial transaction, and then can include further storing the PIN for each debit card for each checking account at the financial services system 20, and thus, the user of the first computer device can enters an access code to access the financial services system 20 that is not necessarily the PIN for the debit card, and the debit card PIN need not be again entered by the user of the computer device to effect the financial transaction as the PIN for the debit card is already stored and accessible to the financial services system 20.

If so embodied, the financial services system 20 will further verify the financial transaction with the electronic transaction network and indicate the verification to the first computer device, as shown in FIGS. 3A-5. Further, if the mobile computer device 12 includes a resident application, then the method includes further holding, at least, access codes for secure accounts linked with the mobile computer device 12, and can include obtaining at the resident application of the mobile computer device 12 financial account data for secure accounts linked to the mobile computer device 12, storing the financial account data at the mobile computer device 12, and selectively updating the financial account data stored at the mobile computer device 12 based upon financial transactions effected from the mobile computer device 12. The resident application can further obtain the financial account data from the secure account transaction network (ACH Network 40) or financial institutions directly.

In view of the methods being executable on a mobile device and other computer platforms, the method can accordingly be performed by a program resident in a computer readable medium, where the program directs the mobile device or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), blu-ray ray disc and floppy disk, where “disks” usually store data magnetically, while “discs” store data optically with lasers. Combinations of the above should also be included within the scope of computer-readable media.

While the invention has been particularly shown and described with reference to a preferred embodiment thereof, it will be understood by those skilled in the art that various changes in form and detail may be made without departing from the scope of the present invention as set forth in the following claims. Furthermore, although elements of the invention may be described or claimed in the singular, the plural is contemplated unless limitation to the singular is explicitly stated.

What is claimed is:

1. A system for effecting a substantially real-time financial transaction between at least one secure account and one other financial account, comprising:
a secure account transaction network that is configured to manage financial transactions between a plurality of secure accounts, at least one of the secure accounts having a first access code thereto;
an electronic transaction network configured to selectively communicate with the secure account network, the electronic transaction network further configured to effect a substantially real-time financial transaction in a secure account on the secure account transaction network utilizing a first access code for that secure account;
a financial services system in selective communication with at least the electronic transaction network, the financial services system configured to receive financial transaction data from at least a first computer device having a user thereof where the user desires to conduct a financial transaction from at least a first secure account linked with the first computer device to a second secure account, and the financial services system further configured to, at least, store first access codes for secure accounts linked with computer devices; and
wherein, upon receipt of a financial transaction data from the first computer device, the financial services system further configured to effect the financial transaction specified in the financial transaction data with the electronic transaction network to effect the financial transaction from the first secure account to the second secure account substantially in real-time.

2. The system of claim 1, wherein the second secure account is linked to a second computer device.

3. The system of claim 1, wherein the first secure account and second secure accounts are checking accounts, and the secure account transaction network is the ACH network.

4. The system of claim 3, wherein the electronic transaction network is an ATM/Debit network.

5. The system of claim 4, wherein the access codes for the secure accounts are debit card numbers.

6. The system of claim 5, wherein the user of the first computer device enters a personal identification number to effect the financial transaction.

7. The system of claim 5, wherein the financial services system further configured to store the a personal identification number for each debit card for each checking account and the user of the first computer device enters an access code to access the financial services system.

8. The system of claim 1, wherein the first computer device is a mobile computer device.

9. The system of claim 1, wherein the financial services system further configured to verify the financial transaction with the electronic transaction network and indicate the verification to the first computer device.

10. The system of claim 8, wherein the mobile computer device further includes a resident application that is configured to hold at least access codes for secure accounts linked with the mobile computer device.

11. The system of claim 10, wherein the resident application is further configured to obtain financial account data for secure accounts linked to the mobile computer device and store the financial account data at the mobile computer device, and the mobile computer device further configured to selectively update the financial account data stored at the mobile computer device based upon financial transactions effected from the mobile computer device.

12. The system of claim 11, wherein the resident application is further configured to obtain the financial account data from the secure account transaction network.

13. A financial services system for effecting a substantially real-time financial transaction between at least one secure account and one other financial account, the system configured for selective communication with at least an electronic transaction network that selectively communicates with a secure account transaction network that manages financial transactions between a plurality of secure accounts with at least one of the secure accounts having a first access code thereto, and the electronic transaction network effecting a substantially real-time financial transaction in a secure account on the secure account transaction network utilizing a first access code for that secure account, the financial services system further configured to receive financial transaction data from at least a first computer device having a user thereof where the user desires to conduct a financial transaction from at least a first secure account linked with the first computer device to a second secure account, and the financial services system further configured to, at least, store first access codes for secure accounts linked with computer devices, and wherein, upon receipt of a financial transaction data from the first computer device, the financial services system further configured to effect the financial transaction specified in the financial transaction data with the electronic transaction network to effect the financial transaction from the first secure account to the second secure account substantially in real-time.

14. The system of claim 13, wherein the second secure account is linked to a second computer device.

15. The system of claim 13, wherein the first secure account and second secure accounts are checking accounts, and the secure account transaction network is the ACH network.

16. The system of claim 15, wherein the electronic transaction network is an ATM/Debit network.

17. The system of claim 16, wherein the access codes for the secure accounts are debit card numbers.

18. The system of claim 17, wherein the user of the first computer device enters a personal identification number to effect the financial transaction.

19. The system of claim 17, wherein the financial services system further configured to store the a personal identification number for each debit card for each checking account and the user of the first computer device enters an access code to access the financial services system, the access code different from the stored personal identification numbers.

20. The system of claim 13, wherein the financial services system further configured to verify the financial transaction with the electronic transaction network and indicate the verification to the first computer device.

21. A financial services system for effecting a substantially real-time financial transaction between at least one secure account and one other financial account, comprising:
a means for selectively communicating with at least an electronic transaction network that selectively communicates with a secure account transaction network that manages financial transactions between a plurality of secure accounts with at least one of the secure accounts having a first access code thereto, and the electronic transaction network effecting a substantially real-time financial transaction in a secure account on the secure account transaction network utilizing a first access code for that secure account;
a means for receiving financial transaction data from at least a first computer device having a user thereof where the user desires to conduct a financial transaction from at least a first secure account linked with the first computer device to a second secure account;
a means for storing first access codes for secure accounts linked with computer devices; and
a means for, upon receipt of a financial transaction from the first computer device, effecting the financial transaction with the electronic transaction network to effect the financial transaction from the first secure account to the second secure account substantially in real-time.

22. A method for effecting a substantially real-time financial transaction between at least one secure account and one other financial account, comprising:
storing access codes for secure accounts linked with computer devices at a financial services system, the access code for secure accounts accessible to a secure account transaction network that manages financial transactions between a plurality of secure accounts with at least one of the secure accounts having a first access code thereto;
receiving financial transaction data from at least a first computer device having a user thereof where the user desires to conduct a financial transaction from at least a first secure account linked with the first computer device to a second secure account; and
effecting the financial transaction specified in the financial transaction data from the first secure account to the second secure account substantially in real-time through the financial services system communicating with an electronic transaction network that selectively communicates with the secure account transaction network, and the electronic transaction network effecting substantially real-time financial transactions in secure accounts on the secure account transaction network through utilizing access codes, the electronic transaction network further effecting the specified financial transaction for the secure account based upon one or more access codes provided from the financial services system.

23. The method of claim 22, wherein storing access codes is further storing an access code for the second secure account that is linked to a second computer device.

24. The method of claim 22, wherein the secure account transaction network is the ACH network, and effecting a financial transaction is effecting a financial transaction between checking accounts.

25. The method of claim 24, wherein the electronic transaction network is an ATM/Debit network and the access codes for the secure accounts are debit card numbers, and further comprising the user of the first computer device entering a personal identification number to effect the financial transaction.

26. The method of claim 24, further storing a personal identification number for each debit card for each checking account at the financial services system, and the user of the first computer device entering an access code to access the financial services system.

27. The method of claim 22, wherein effecting a financial transaction from the first computer device is effecting a financial transaction from a mobile computer device.

28. The method of claim 22, wherein the financial services system further verifying the financial transaction with the electronic transaction network and indicating the verification to the first computer device.

29. The method of claim 27, wherein the mobile computer device includes a resident application further holding, at least, access codes for secure accounts linked with the mobile computer device.

30. The method of claim 29, further:
obtaining at the resident application of the mobile computer device financial account data for secure accounts linked to the mobile computer device;
storing the financial account data at the mobile computer device; and
selectively updating the financial account data stored at the mobile computer device based upon financial transactions effected from the mobile computer device.

31. The method of claim 30, further obtaining at the resident application of the mobile computer device the financial account data from the secure account transaction network.

32. A computer-readable product, comprising:
a computer-readable medium, comprising:
a set of instructions for a financial services system to store access codes for secure accounts linked with computer devices, the access code for secure accounts accessible to a secure account transaction network that manages financial transactions between a plurality of secure accounts with at least one of the secure accounts having a first access code thereto;
a set of instructions for a financial service system to receive financial transaction data from at least a first computer device having a user thereof where the user desires to conduct a financial transaction from at least a first secure account linked with the first computer device to a second secure account; and
a set of instructions for the financial services system to effect the financial transaction specified in the financial transaction data from the first secure account to the second secure account substantially in real-time through the financial services system communicating with an electronic transaction network that selectively communicates with the secure account transaction network, and the electronic transaction network effecting substantially real-time financial transactions in secure accounts on the secure account transaction network through utilizing access codes, the electronic transaction network further effecting the specified financial transaction for the secure account based upon one or more access codes provided from the financial services system.

33. The computer-readable product of claim 32, further comprising:
a computer-readable medium, comprising:
a set of instructions for the financial services system to verify the financial transaction with the electronic transaction network and indicate the verification to the first computer device.
